(19) United States
(12) Patent Application Publication
(10) Pub. No.: US 2013/0021475 A1
(43) Pub. Date: Jan. 24, 2013

(54) SYSTEMS AND METHODS FOR SENSOR CONTROL

(71) Applicants: Ross L. Canant, Quinlan, TX (US); Chris Cowan, Terrell, TX (US); Levi Pope, Greenville, TX (US)

(72) Inventors: Ross L. Canant, Quinlan, TX (US); Chris Cowan, Terrell, TX (US); Levi Pope, Greenville, TX (US)

(21) Appl. No.: 13/354,561

(22) Filed: Jan. 20, 2012

Related U.S. Application Data
(60) Provisional application No. 61/572,772, filed on Jul. 21, 2011.
(60) Provisional application No. 61/572,932, filed on Jul. 25, 2011.

(51) Int. Cl. H04N 7/18; H04N 5/33; G06F 3/048

(52) U.S. Cl. 348/144; 348/E07.085; 348/E05.09

(57) ABSTRACT

Systems and methods that may be employed to manage and control imaging sensors (e.g., such as gimbaled video image sensors), and/or manage and control the data produced by such imaging sensors.

This application claims the benefit of U.S. Provisional Patent Application No. 61/572,772, filed on Jul. 21, 2011 and entitled “Tactical Video Exploitation System”, and this application also claims the benefit of U.S. Provisional Patent Application No. 61/572,932, filed on Jul. 25, 2011 and entitled “Systems And Methods For Sensor Control”, and each of the above identified provisional patent applications is hereby incorporated herein by reference in its entirety for all purposes.

### FIELD OF THE INVENTION

This invention relates generally to video sensors, and more particularly to management and control of imaging sensors and/or the image data produced from such sensors.

### BACKGROUND

Turret or gimbal-mounted video electro-optic and infrared sensor (EO/IR) systems have been employed on manned and unmanned airborne vehicles (UAVs). These systems have been used to collect real time video and sensor data of the ground, and may be transmitted as sensor data to a ground station for further processing. In the case of remote UAV systems, electronic joystick control has been provided in combination with a remote video display to allow a ground-based user to control the movement of such EO/IR sensor turrets in order to change the field of view of the EO/IR sensors in real time. Metadata that is generated by conventional EO/IR sensor systems include information such as sensor center point, sensor slant range, sensor elevation angle, sensor roll angle, sensor azimuth angle, sensor field of view. This metadata is transmitted to the ground separately from the image data, and then combined by the ground processing system in order to assign location coordinates to the real time center point location (e.g., crosshair intersection) of the EO/IR sensor view. The ground-based user may select a target location within the real time field of sensor view by using the joystick to move the sensor turret until the center point (crosshairs) of the field of view are aligned with the target. The metadata corresponding to the selected target location is then provided to the weapon system for targeting purposes. Time differences of arrival between the metadata and image data, along with transmission delays for both, make it difficult to accurately point the sensor and to accurately align the metadata with the corresponding image data.

The Motion Imagery Standards Board (MISB) was established by the United States Department of Defense (DOD) under the National Geospatial Intelligence Agency (NGA) to standardize motion imagery data collected by US DOD imagery systems. MISB has developed motion imagery standards that are employed by the United States Department of Defense, United States Imagery and Geospatial System, and members of the intelligence community. These standards also govern metadata and audio associated with motion imagery. These standards are also adopted by North Atlantic Treaty Organization (NATO) through NATO Standards Agreement (STANAG) 4609.

### SUMMARY OF THE INVENTION

Disclosed herein are systems and methods that may be employed to manage and control imaging sensors (e.g., such as gimbaled video image sensors) and/or the data produced by such imaging sensors. In one exemplary embodiment, the disclosed systems and methods may be implemented as a tactical video exploitation system (TVS) that may be configured to provide complete mission management of video electro-optical/infrared (EO/IR) gimbaled sensors. Such a TVS may be implemented to provide low latency encoding of EO/IR video, allowing for sensor control by interacting directly with the image pixels. This may be accomplished in one embodiment by geo-locating image pixels on the fly as they are received and rendered. A TVS may be further configured in one exemplary embodiment to provide one or more of the following basic operational functions for an image sensor system: viewing, sensor control, map interaction, target management, recording, and/or encoding/routing. TVS software may be built around the concept of web services and, as such, may be configured to be inherently interoperable with other networked services such as map servers and other XML-based data interchange programs.

In one example, such a TVS system may include a compressed video recorder and database that may be MISB compliant, a key-length-value (KLV) encoder/router, a MISB compliant compressed video viewer with exploitation tools, a target manger database application, and sensor control tools. In such an implementation, a gimbaled EO/IR sensor may be coupled to the encoder for video compression and network transmission to one or more users (e.g., such as one or more ground-based operators). The sensor may also be coupled to a mission system (e.g., one or more portable computer systems such as notebook computers or other suitable computer processing systems) for sensor control and sensor status monitoring. The encoder may also be connected to the mission system for providing status and control, and for purposes of providing KLV data to the mission system. The encoder may be configured to multi-cast compressed video data to a network, e.g., to allow recording and viewing simultaneously, to allow multiple local and/or remote users to view live and/or recorded data, etc.

Exemplary system and method embodiments disclosed further herein may include, but are not limited to, the following listed components, features and/or functionalities that may be implemented alone or in various combinations:

In one exemplary embodiment, a transport stream encoder may be provided that accepts a video input stream, e.g., such as a video input stream provided in the form of NTSC, PAL, HDMI, and HD-SDI. The stream encoder may also accept metadata, e.g., as provided from a sensor such as a L-3 Communications Wescam MX series or FLIR Systems Star Safire series electro-optic (EO)/infrared (IR) turret-mounted sensor or an inertial navigation guidance/position system such as a Custom Sensor and Technologies miniature integrated GPS/INS tactical system (CMIGITS), Northrop Grumman LN100, BEI Systron Donner MEMS-based Digital Quartz Inertial Measurement Unit (DQI), etc. where such metadata has been normalized by the system into KLV formatted metadata. The stream encoder may in turn output KLV encoded data (e.g., KLV 601.4) in a full Motion Imagery Standards Board (MISB) compliant (e.g., MISP 5.4 or 5.5) output stream.

In another exemplary embodiment, a video/metadata physical architecture may be provided that connects a sensor to an encoder for video compression and network transmission. In this embodiment, the sensor may also provide KLV data in High Definition-Serial Digital Interface (HD-SDI), and may be connected to a mission system (e.g., computer system) for control and status. This sensor-to-mission system connection may be either Ethernet or Serial. The encoder may also be connected to the mission system for status and control, and to provide KLV data. A network switch may be provided that is configured to pass compressed video and associated data. The mission system may be a single computer or a multi-computer system. Encoders may be provided that are configured to multi-cast compressed video data to a network, e.g., so as to allow recording and viewing simultaneously and to also allow multiple users or operators to view the data, live or recorded.

In another exemplary embodiment, a TVS system may be provided with a Tactical Digital Video Recorder that has the following features:
Accepts MISP compliant Transport Stream
Accepts MPEG 2, MPEG 4 Part 2, and H.264 streams
Records stream data to file system in configurable chunk sizes
Builds database records of metadata for each video chunk file
Provides SQL query interface to recall video data
Re-streams files on request
Accepts snapshot files for cataloging into a database

In another exemplary embodiment, a TVS system may be provided with a Tactical Digital Video Player that has the following features:
Full Digital Video Player
Viewing control (fast forward, pause, rewind, etc.) of live video streams or playback of recorded video streams
Display of MISP compliant metadata with the video
Provides snapshots in NITF 2.1, JPEG, TIF, GeoTif, BMP formats
Provides bookmarks with text and geo-location recorded to database
Video Editing capability
Interfaces to map applications such as Google Earth, Envitia Maplink Pro, NASA World Wind, ArcMap, etc.
Sensor control via direct interaction with a video window

In another exemplary embodiment, a TVS system may be provided with a Tactical Target Manager having the following features:
User definable fields and categories
Sensor control (cueing)
Map and video display of targets
Automated chipout of still images containing the target in NITF2.1 format
Automated bookmark of video streams containing the target
Multi-user synchronization
Accepts Cursor on Target (COT) and SensorWeb target data

In another exemplary embodiment, a TVS system may be provided with a Tactical Situation Awareness Map having the following features:
Sensor control from map surface
Live and replay mapping of sensor footprint and aircraft telemetry
Display of target information
3 Dimensional representation of aircraft telemetry
3 Dimensional draping of registered still images over terrain data
May be based on map application feature such as a Google Earth plug-in or plug in other suitable application such as Envitia Maplink Pro, NASA

World Wind, ArcMap, etc.

In another exemplary embodiment, a TVS system may be provided with a Sensor Control Functionality having the following features:
Sensor Steering in the video window based on Azimuth and Elevation offsets and rates to simulate the direct panning of a camera lens.
Sensor Pointing in the video window by geo-locating individual pixels to provide a geo-point to the sensor.
Sensor feature control implemented on the control workstation providing the features and selections normally provided on the sensor joystick and sensor menu system

It will be understood that some embodiments may include only a portion of the above listed components, features and/or functionalities, and that other embodiments may include additional and/or alternative components, features and/or functionalities.

In one respect, disclosed herein is a sensor system, including: a first sensor; at least one processing device coupled to receive image data and associated geospatial metadata from the first sensor, and coupled to provide video information to a video display; and a sensor platform, with the first sensor being located on the sensor platform. The processing device may be programmed to provide video information to a video display that is based at least in part on the received image data and the embedded associated geospatial metadata. The processing device may also be programmed to accept one or more commands from a user that are referenced to the embedded geospatial metadata associated with the image data to specify at least one selected geolocation within the image data. In response, the processing device may be programmed to respond to the user commands by selecting image data corresponding to the selected geolocation specified by the user commands and providing the selected image data as video information for display to the user on the video display. Alternatively or additionally, where the first sensor is a first pointable sensor, the processing device may be programmed to respond to the user commands by controlling pointing of the first sensor based on the selected geolocation specified by the user commands.

In another respect, disclosed herein is a method including: providing a first sensor; providing a video display; providing at least one processing device coupled to receive image data and associated geospatial metadata from the first sensor, and coupled to provide video information to the video display; using the processing device to provide video information to the video display that is based at least in part on the received image data and the embedded associated geospatial metadata; and using the processing device to accept one or more commands from a user that are referenced to the embedded geospatial metadata associated with the image data to specify at least one selected geolocation within the image data. The method may further include using the processing device to respond to the user commands by selecting image data corresponding to the selected geolocation specified by the user commands and providing the selected image data as video information for display to the user on the video display. Alternatively or additionally, where the first sensor is a first pointable sensor, the method may include using the processing device to respond to the user commands by controlling pointing of the first sensor based on the selected geolocation specified by the user commands.

In another respect, disclosed herein is a system including: at least one processing device configured to receive image data and associated geospatial metadata from a first sensor, the processing device being programmed to execute at least one image server component and at least one user interface component. The processing device may also be programmed to execute the image server component to provide the received image data with the associated geospatial metadata to the user interface components, the associated geospatial metadata being embedded with the image data. The processing device may also be programmed to execute the user interface component to provide a display to a user that is based at least in part on the received image data and the embedded associated geospatial metadata. The processing device may also be programmed to execute the user interface component to accept commands from a user that are referenced to the embedded geospatial metadata associated with the image data to specify at least one selected geolocation within the image data, and in response to the user commands to provide control data to the image server component that is referenced to the embedded geospatial metadata associated with the image data to specify the at least one selected geolocation. The processing device may also be programmed to execute the image server component to respond to the control data by selecting image data corresponding to the selected geolocation specified by the control data and providing the selected image data back to the user interface component for display to the user. Alternatively or additionally, where the first sensor is a first pointable sensor, the processing device may additionally or alternatively programmed to execute the image server component to respond to the control data by controlling pointing of the first sensor based on the selected geolocation specified by the control data.

### BRIEF DESCRIPTION OF THE DRAWINGS

FIG. 1 illustrates a sensor platform in the form of an aircraft according to one exemplary embodiment of the disclosed systems and methods.

FIG. 2A illustrates a block diagram of a tactical video exploitation system (TVS) according to one exemplary embodiment of the disclosed systems and methods.

FIG. 2B illustrates a main window of a Tactical Video Viewer (TVV) graphical user interface (GUI) according to one exemplary embodiment of the disclosed systems and methods.

FIG. 2C illustrates a main window of a Tactical Situational Awareness Map (TSAM) GUI according to one exemplary embodiment of the disclosed systems and methods.

FIG. 3A illustrates a TVS video/metadata physical architecture according to one exemplary embodiment of the disclosed systems and methods.

FIG. 3B illustrates a TVS encoder configuration according to one exemplary embodiment of the disclosed systems and methods.

FIG. 3C illustrates a TVS encoder configuration according to one exemplary embodiment of the disclosed systems and methods.

FIG. 4 illustrates a motion imagery cued exploitation (MICE) architecture according to one exemplary embodiment of the disclosed systems and methods.

FIG. 5 illustrates aTVV GUI main window as it may be generated using the MICE architecture of FIG. 4 according to one exemplary embodiment of the disclosed systems and methods.

FIG. 6 illustrates a TVV GUI main window as it may be generated using the MICE architecture of FIG. 4 according to one exemplary embodiment of the disclosed systems and methods.

### DESCRIPTION OF ILLUSTRATIVE EMBODIMENTS

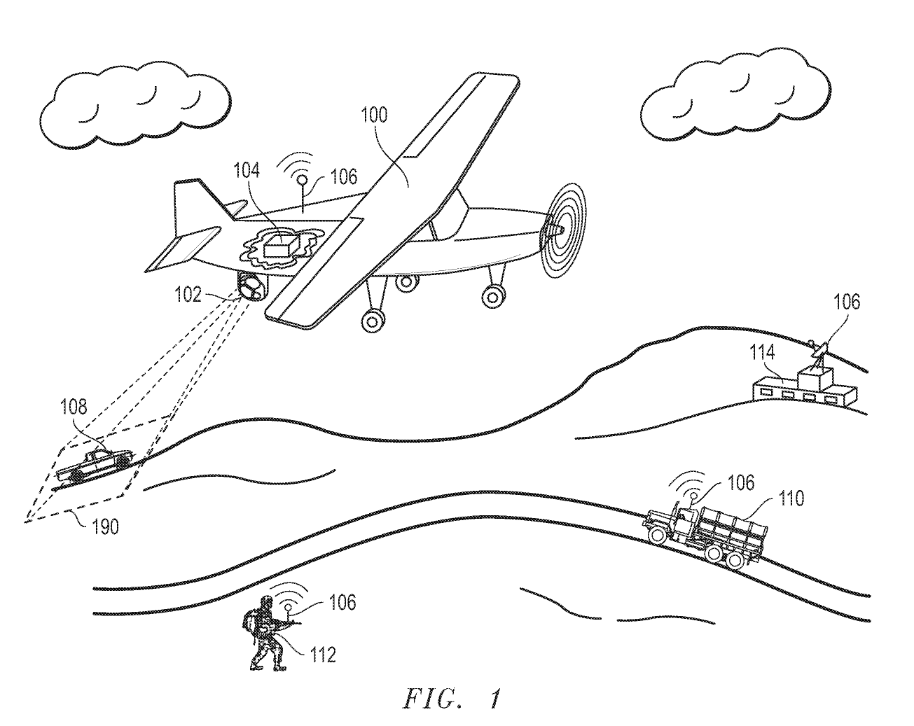

FIG. 1 illustrates an exemplary embodiment of a sensor platform in the form of an aircraft 100 that includes a tactical video exploitation system (TVS) 104 contained thereon. As shown, the TVS 104 is communicatively coupled to a gimbaled sensor 102 having a movable sensor footprint or surveillance area 190. In FIG. 1, sensor 102 has acquired and is tracking a land-based mobile target 108 that is in motion on the ground. Also shown present in FIG. 1 are remote ground-based user communication systems that include a vehicle-based communication system 110, a handheld communication system 112, and a stationary facility-based communication system 114. As shown in FIG. 1, each of sensor platform 100 and remote user communication systems 110, 112 and 114 are provided with communication antennas 106 for wirelessly exchanging data therebetween in a manner as will be described further herein. It will be understood that TVS 104 may simultaneously communicate and display information via network datalink in the manner described herein to one or more of remote user communication systems (e.g., systems 110, 112, 114), and/or at the same time as displaying information to a local operator that is present on platform 100.

It will be understood that these example remote user communication systems are exemplary only, and that any other type of stationary or mobile remote user communication systems may be employed including, but not limited to, aircraft based systems, space-based systems, sea-based systems, etc. Moreover, it will also be understood that a TVS 104 may be provided and operated on any other type of sensor platform including, but not limited to, stationary or mobile platforms that are space based, sea-based, land-based, etc. Specific examples of sensor platforms include, but are not limited to, ship, vehicle, building, structure, or individual. It will also be understood that the mobile target 108 is exemplary only, and that the disclosed systems and methods may implemented for tracking and/or observing other types of mobile or stationary targets (e.g., sea-based vehicles, air-based vehicles, land-based facilities, defined geographical areas, etc.).

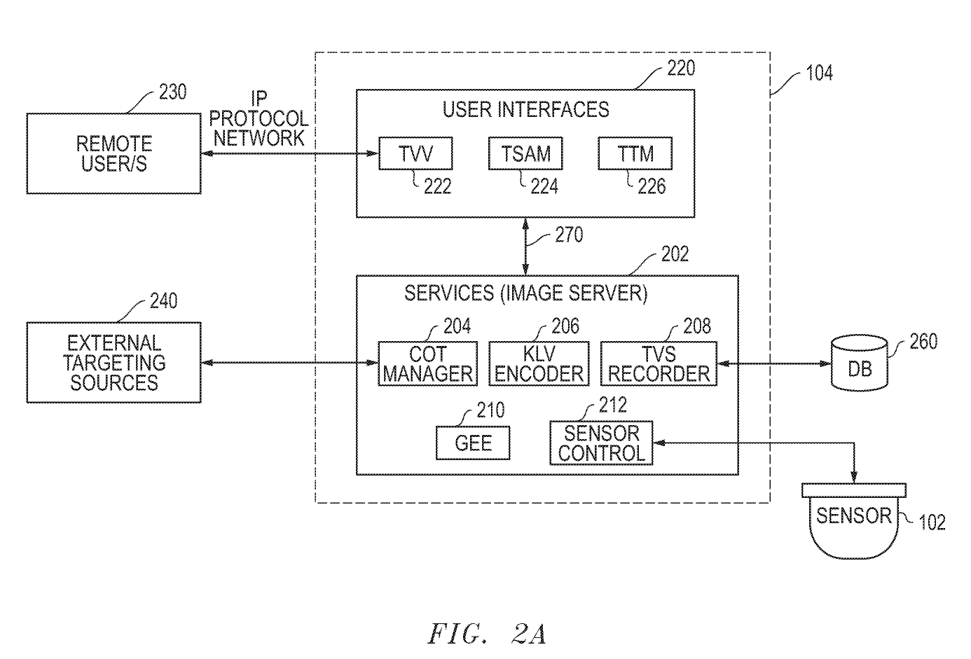

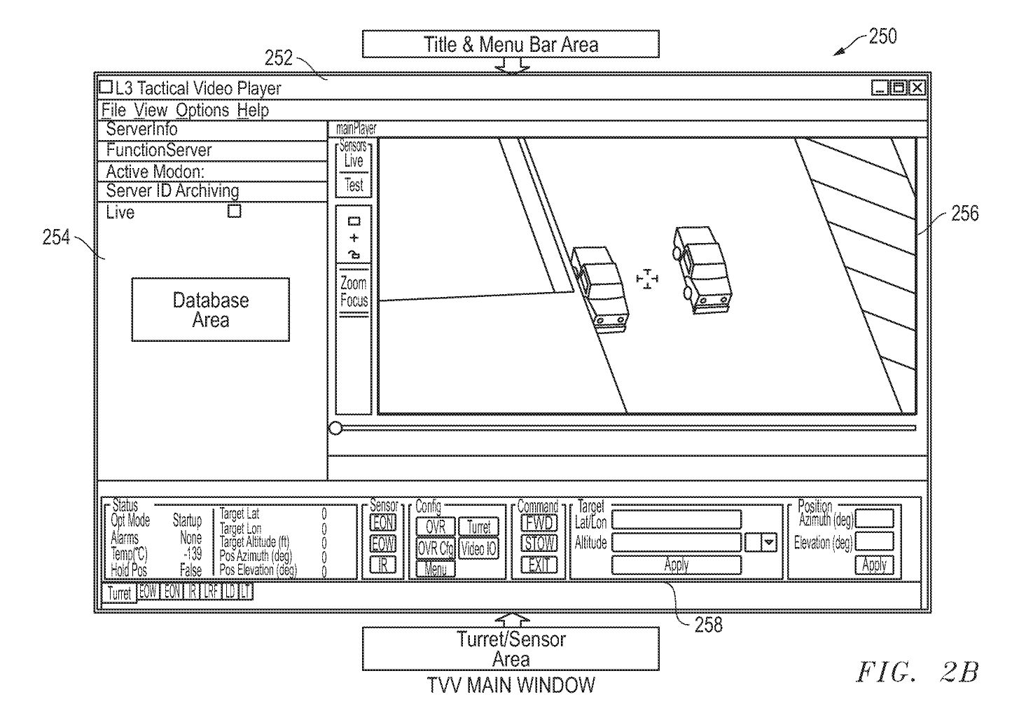

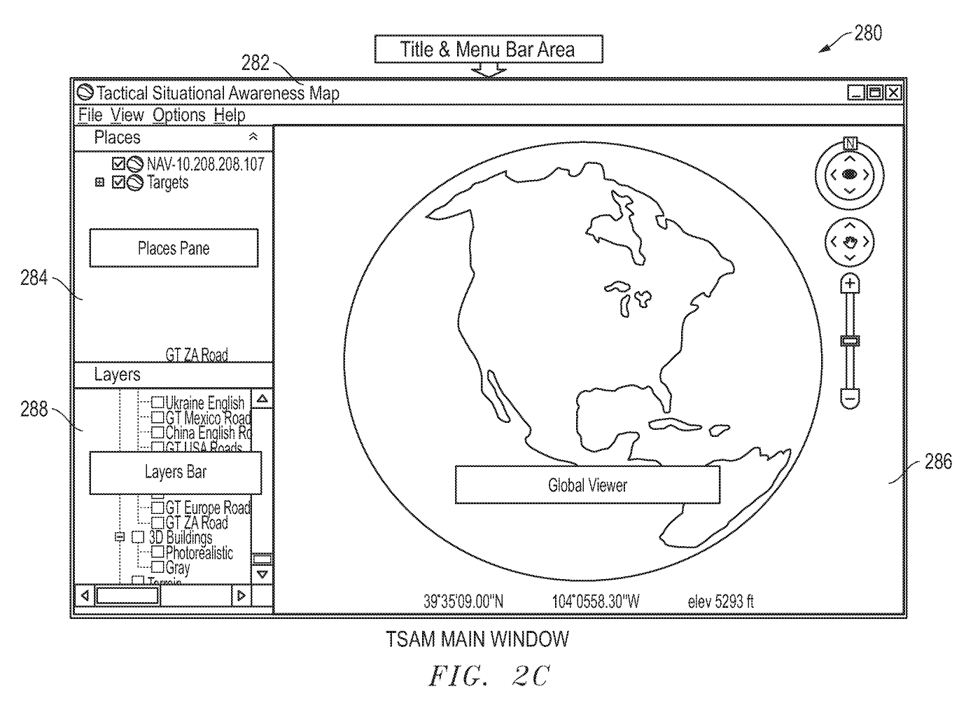

FIG. 2A illustrates one exemplary embodiment of the functional components of TVS 104 as the may be configured in one exemplary embodiment in relation to a database 260, sensor/s 102, targeting source/s 240 and remote user/s 230. In the embodiment of FIG. 2A, a first group 220 of user interface functional components may be present to provide the primary user interface for an user of sensor 102. A second group 202 of image server components may communicate with user interface components 220, and may be present to provide background services to support video manipulation, editing, and recording capabilities of TVS 104. As shown, image server components 202 may be coupled to a sensor device 102 which may be, for example, an electro optic sensor such as charge coupled device (CCD), complementary metal oxide semiconductor (CMOS), infrared focal plane array (FPA). Sensor 102 may also be any other type of suitable sensor device such as a radar sensor, and may be provided as part of a gimbaled radar sensor. Image server components 202 may also be coupled to a database 260 as shown. In one exemplary embodiment, the functional components of TVS 104 may be provided as application programs that run on an operating system such as Microsoft Windows-based operating system or Linux-based operating system of a computer system that may be a notebook computer, laptop computer, or other suitable computer system or combination of computer systems.

In the exemplary embodiment of FIG. 2A, user interface functional components 220 may include a Tactical Video Viewer (TVV) 222, Tactical Situational Awareness Map (TSAM) 224, and a Tactical Target Manager (TTM) 226. As previously described, these functional components may be provided, for example, as applications that execute on one or more programmed processing devices (e.g., CPU, microprocessor, ASIC, FPGA, etc.) of a sensor operator's workstation and/or or on another computer dedicated for support services. Such a workstation or other computer may be co-located with a local user on the sensor platform 100, and/or may be alternatively co-located with a user 230 that is positioned remote to platform 100, such as positioned on the ground or on another separate platform. Such a workstation or other computer may be provided in one exemplary embodiment as a notebook computer, desktop computer, etc.

In this embodiment, a second group 202 of image server components may be present to provide background services to support video manipulation, editing, and recording capabilities of TVS 104. It will be understood that multiple local and/or remote groups of interface functional components 220 may be coupled to a given instance of image server components 202, and/or that a given instance of local or remote interface functional components 220 may be coupled to control multiple image server component sets 202 and corresponding sensors 102. As shown for this exemplary embodiment, these image server functional components 202 may include a Tactical Video Server (TVS) recorder 208, cursor on target (COT) Manager 204, and KLV encoder/router 206, each of which may in one embodiment also be applications that execute on processing device/s of a sensor operator's workstation, or alternatively may be distributed (e.g., over one or more other computers) that operate within and across a mission system IP network. As such, one or more components of a TVS mission system may be physically located at different locations, remote to and/or local to platform 100, and communicate with across the network. For example, in one exemplary embodiment, only encoder 206 and sensor 102 may be located on platform 100, with other hardware and software components of the mission system being located remote to platform 100 and communicating with each other across the network. Other components of image server functional components 202 may include, for example, Google Earth Enterprise or Google Earth Portable server (GEE) component 210 and sensor control component 212 that communicates directly with sensor 102.

In the exemplary embodiment of FIG. 2A, Tactical Video Viewer (TVV) 222 may be used as the primary graphic user interface (e.g., by presenting a graphical user interface GUI on a local or remote video display) for TVS 104. In this role, TVV 222 may be configured to allow a user to display, edit, query, render, exploit, and export both still and video imagery of the TVS 104, as well as to allow the viewing of live and recorded video and still imagery. TVV 222 may also be configured to provide for full operator control of the sensor 102. TVV 222 may also be configured to function as a control center that provides for full operator control of the sensor 102, and as an exploitation tool for exploring the historical database 260, comparing to current events, extracting imagery of interest (either video or stills) and assembling that imagery into collections for dissemination. TVV 222 may be configured in any suitable user interface configuration, and may include a main window for providing interface for a user. In one exemplary embodiment, TVV 222 may be configured as a video viewer and controller that provides for one or more video windows, e.g., which may be arranged for viewing according to the operator's preference. The possible number of such video windows is only limited by the system resources.

FIG. 2B illustrates one embodiment of a main window 250 of TVV GUI 222, it being understood that the illustrated is embodiment is exemplary only, and may be configured in a variety of other suitable manners with additional, fewer, and/or alternative functionalities. In the exemplary embodiment of FIG. 2B, main window 250 of TVV GUI 222 includes four main areas for providing the user a visual display of the system viewer capabilities. These four main areas are: Title & Menu Bar Area 252, Database Area 254, Video Viewing Area 256, and Turret/Sensor Area 258. It will be understood that these areas may vary depending on system configuration, and that not all areas or panels may be present. As shown, in this exemplary embodiment, Title & Menu Bar Area 252 may include an upper bar (Title) that displays title of the main TVV window; and a lower bar (Menu) displays four drop-down menus (File, View, Options, Help) of the TVV main window 250. The Database Area 254 may include five separately functioning tab panes: ServerInfo tab, Media tab, Chips tab, Query tab and Clips tab. Along the main window Title Bar (Upper portion of Title & Menu Bar Area 252) the TVV is identified as “Tactical Video Viewer”. The Menu Bar (Lower portion of Title & Menu Bar Area 252) includes four drop-down menus (File, View, Options & Help) for performing various TVV wide functions. Video Viewing Area 256 (aka mainPlayer) may include four functional sub-sections: Video Player Panel, Sensors Panel, Controls panel, and Video Editing Control panel.

In one exemplary embodiment, TVV 222 may be configured to implement Review/Edit/Mark/Record functions. In such an embodiment, a time slider control and standard VCR-like buttons may be provided to allow for quickly scanning or skipping over a video segment to the events of interest. Editing capabilities may include, but are not limited to, the ability to place markers (with or without annotation) into the video with a single mouse click, the ability to extract a still image with a single mouse click, and the ability to select a segment of video with a sweep of the mouse and extract the clip with an additional click. Such capabilities may be configured to be present not only for recorded playbacks, but for live sensor video streams as well. In this regard, events in a live stream may be quickly reviewed and stills or clips extracted without interrupting the ongoing stream; and viewing of live video may continue while editing or may be resumed quickly when done. TVV 222 may also be configured such that recording of live streams are also controllable through the viewer interface, e.g., during transit or non-significant portions of a mission recording may be turned off to conserve file space, and then quickly resumed when desired.

TVV 222 may also be configured to provide for live (real time) sensor control of a sensor 102, either locally and/or remotely. For example, in one exemplary embodiment, TVV 222 may be configured such that full control of the pointing of a gimbaled sensor 102 (including live control of slew, azimuth, and elevation of the sensor) may be intuitively directed by a local or remote operator, e.g., by dragging and pointing with a mouse cursor on a local or remote video display surface. In this regard, one or more remote user/s 230 may be in communication with TVV 222 of user interface components 220 of TVS 104 via a network (e.g., IP protocol network) or other suitable network technology as shown.

In one exemplary embodiment, geospatial metadata present in a data stream 270 provided from image server 202 may be provided to allow control of the sensor 102 in a real-world (outside the platform) frame of reference which many operators find intuitive. In addition, interaction with an imagery database 260 may be provided to allow for rapid sensor pointing at historical targets or areas of interest that are stored in the database 260. TVS 104 may also be configured to allow for reception of targeting information from external sources 240, e.g., which can be used both to aim the sensor 102 and to place appropriate dynamic annotation on the video display (such as target location probability of confidence ellipses) projected into the appropriate frame of reference.

Video data stream 270 may include complete embedded geospatial metadata, and information of this data stream may also be stored in database 260. Because in one embodiment the stored video stream data may include complete embedded geospatial metadata, full sensor reference information may be available to a local or remote user on a frame-by-frame basis. In such a case, the imagery database 260 (e.g., including videos, stills, and markers within videos) is searchable by a user on a geospatial basis as well as by explicit annotation within markers. For example, the database 260 may quickly be queried for imagery based on both location and time as well as for explicit tags such as targets or events of interest which may have been marked during collection or post-mission review. Imagery of interest may be quickly displayed simply by dragging and dropping onto the video player area.

A sensor/turret control panel may also be provided within the TVV 222 to provide for detailed control (e.g., of a gimbaled sensor ball), including control and review of all sensor parameters including camera selection, overlays, status, and Built in Test data (BIT). The TVV 222 may also be configured to interoperate with a Tactical Situational Awareness Map (TSAM) 224 to provide a synchronized map display (e.g., in 2D or 3D) of sensor and platform geospatial information for both live and/or playback streams.

Working in conjunction with the TVV 222, the TSAM 224 may be implemented to provide additional options for sensor pointing control. In one exemplary embodiment, the TSAM 224 may also facilitate the management of the database 260 in the form of target lists.

As further shown in FIG. 2A, a Tactical Situational Awareness Map (TSAM) main window component 224 may additionally be optionally provided for local or remote user interaction with TVS 104. TSAM 224 may be used to integrate databases of TVS 202 and TTM 226 into 3D mapping. For example, in one exemplary embodiment, the TSAM 224 may be implemented as a three dimensional map viewer, e.g., based on a commercially available Google Earth Plug-in or other map application (e.g., Envitia Maplink Pro, NASA World Wind, ArcMap, etc.) which may provide the user with important situational awareness in a simple and intuitive form, or using any other suitable format. In this regard, TSAM 224 may be configured to visualize for the operator the relative position of the sensor footprint and collecting platform 100 on a map application view such as Google Earth map view.

In one exemplary embodiment, TSAM 224 may be configured to work in conjunction with TVV 222 to provide a geographical near real-time situational awareness to the user, and geospatial metadata associated with the current displayed video data stream 270 may be provided to TSAM 224, which may then display this video data dynamically on a map surface. TSAM 224 may be configured to utilize a Google Earth Plug-in or other map application (e.g., Envitia Maplink Pro, NASA World Wind, ArcMap, etc.) to provide video map viewing and position, and to display the relative position of the sensor/aircraft/operator 100 and target 108 to create an animated image of the sensor/aircraft/operator 100 and target 108 synchronized with the movement of video in the TVV 222, and to then display it on the TSAM main map viewing screen 282 described further below. In one exemplary embodiment, the “footprint” of the sensor video, along with the platform telemetry and sensor field-of-view perspective lines extending from the sensor 102 to the sensor footprint 190 (e.g., the sensor “pyramid”), may be displayed on the map and viewable by the user in conventional 2D (plan view) or 3D (perspective view) forms. TSAM 224 may also provide sensor pointing control for sensor 102.

FIG. 2C illustrates one embodiment of a main window 280 of a TSAM GUI 224, it being understood that the illustrated is embodiment is exemplary only, and may be configured in a variety of other suitable manners with additional, fewer, and/or alternative functionalities. In the exemplary embodiment of FIG. 2C, main window 280 of TSAM GUI 224 includes four main sections or areas for providing the user with the ability to manipulate and obtain a map view of the target area 190 and the sensor/aircraft/operator 100 relative position. The four main sections or areas of this exemplary embodiment are: Title & Menu Bar 282, Places Bar 284, Globe Viewer 286, and Layers Pane 288. It will be understood that these areas may vary depending on system configuration, and that not all areas or panels may be present. As shown, in this exemplary embodiment, Title & Menu Bar Area 282 may include an upper Title bar which displays the application name; and a lower Menu bar which displays drop-down menus containing controls for the TSAM main window 280. For example, along the main window title bar (Upper portion of Title & Menu Bar Area) the TSAM 280 is identified in this embodiment as “Tactical Situational Awareness Map”. The Menu Bar (Lower portion of Title & Menu Bar Area 282) contains five drop-down menus (File, Edit, View, Tools & Help) that function as controls for performing various TSAM wide functions.

In the illustrated embodiment, the Globe Viewer 286 is where an user may be allowed to maintain the situational awareness of both the sensor 102 and target 108. It is here where mapping features of a mapping application such as Google Earth or other suitable mapping application (e.g., Envitia Maplink Pro, NASA World Wind, ArcMap, etc.) may be displayed and manipulated by the user. The Places bar 284 may contain all targets listed in Tactical Target Manager (TTM) 226 and currently playing video streams in TVV 222. The user may be allowed to locate these items on the Globe Viewer 286, e.g., by double-clicking the desired item with an user mouse. The Places bar 284 of this embodiment may also contain Placemarks, Ground Overlays, Screen Overlays and other Keyhole Markup Language (KML) or compressed KML (KMZ) formatted data. The Layers bar 288 may be provided in one embodiment to provide a way by which the user may control display of additional map viewing features such as Borders and Labels, Road Overlays, Terrain features, 3-D buildings, etc.

With the context provided by the map itself (e.g., roads, places of interest, symbology, aerial or satellite photography) the larger context of how the video is being (or was being) collected may be readily apparent. In one embodiment, TSAM 224 may show the sensor field-of-view not only for a live stream but for any and all recorded streams being played back by the TVV 222. In this manner, it is possible to rapidly see the geospatial context for a number of collections both live and historical. In addition, TSAM 224 may be configured to overlay geo-registered still imagery from the mission database 260 onto the map, providing additional contextual information for the user or operator. Symbology, such as target location and annotations (e.g., such as target location ellipses) may also be displayed on the map so that TSAM 224 displays target location data. Annotations may be dynamic (based on live data) or static (based on historic information in the database 260). TSAM 224 may be configured to interoperate with the Tactical Target Manager (TTM) 226 (discussed further below) to display information associated with target lists.

TSAM 224 may also be configured to work in conjunction with the TVV 222 to provide another mechanism for intuitive sensor control in the form of geo-referenced sensor control. Map locations (including annotated points of interest such as named targets) may be selected on the TSAM map display and the sensor 102 automatically slewed to point at the specified location. The sensor operator may be freed from having to figure out relative target bearing and elevation in order to direct the sensor 102. For example, sensor pointing may be configured to be as easy as “point and click”.

FIG. 2A also illustrates a tactical target manager (TTM) component 226 of user interface 220 that may be provided for an operator of sensor 102 to create, modify, import, export and/or assign targets and target types. TTM 226 is configured to facilitate operator interaction with data base 260 and other components of TVS 104 that may be provided in the form of target lists that may be displayed by TTM 226. For example, such target lists may be predefined, created pre-mission using TTM 226, or received from outside or external sources 240 and imported into TTM 226. In one exemplary embodiment, target lists may also be dynamic, including tip-offs from other live intelligence sources in the form of Cursor-On-Target (COT) nomination messages.

In one exemplary embodiment, TTM 226 may be implemented to reduce operator workload and to allow the operator to concentrate on the problem at hand, e.g., by displaying targets as one or more filtered target lists. In this regard, targets may be queried and filtered based on a wide variety of criteria. Once a particular target is selected within a target list, the TTM 226 may be configured to give quick operator access to all historical information about that target in the imagery database. For example, all videos, stills, and markers that are associated with that target may be made available at a glance. The TTM 226 may be configured in one exemplary embodiment to allow a sensor operator to double click an image icon to bring up a viewer to review the imagery on local or remote video display.

TTM 226 may also be configured to allow an operator to easily control the automatic gathering of imagery on a target. For example, the user may be allowed to designate a target through the TTM 226 for “Auto-Mark” and/or “Auto-Chip” recording. During Auto-Mark recording, every time the sensor view passes over the designated target location, an automatic marker is created in the video stream. During Auto-Chip recording, a still image or chip is automatically created. The operator may also be allowed through the TTM 226 to control whether symbology for each target is displayed in the TVV 222 and/or the TSAM 224.

Still referring to FIG. 2A, image server components 202 may include a Tactical Video Server (TVS) 208 component that is configured as the primary database and Data Recorder of TVS 104. In this regard, TVS 208 may be configured to manage the database 260 by organizing and cataloging TVS data (e.g., Video, Still, Target files) and performing recording of live sensor (e.g., video) streams from sensor 102. In one exemplary embodiment, TVS 208 may be configured to run unobtrusively, either on the operator's workstation or on another computer dedicated for support services, and may have a minimal user interface. In one exemplary embodiment, the main direct operator interaction with TVS 208 may be to define a specific mission identifier (ID) prior to beginning a mission.

In one embodiment, TVS 208 may be configured to segment the database 260 to store all of that mission's imagery in a portion of the database 260 that is dedicated to the mission. TVS may also be used to define various recording parameters which affect the size and number of video files created during live stream recording. Additionally, TVS 208 may be configured to import and export mission data. During operation, TVS 208 may be configured, for example, to automatically start upon bootup of the computer or other processing device/s upon which TVS 208 is running, or when an appropriate operator account is logged into on the computer or other processing device/s upon which TVS 208 is executing.

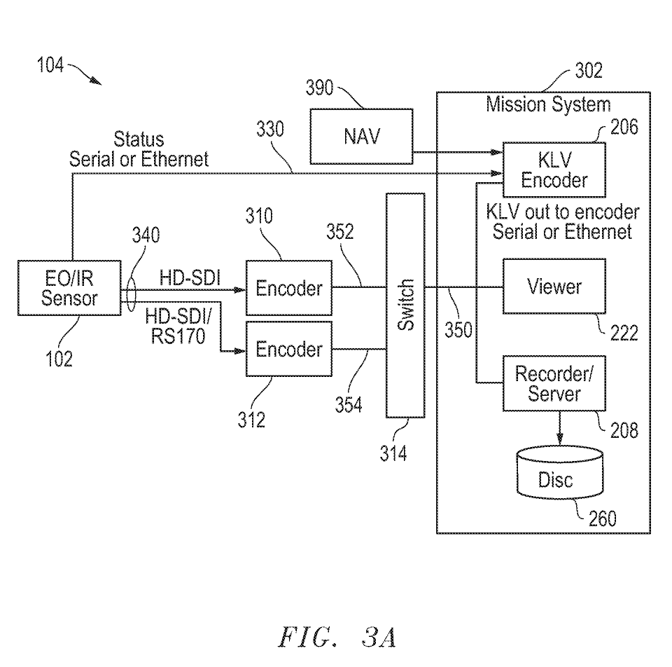

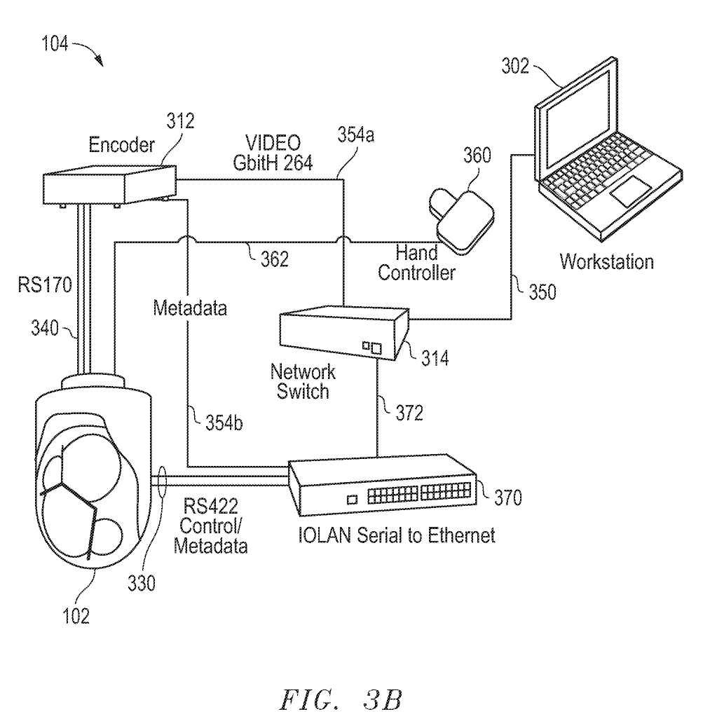

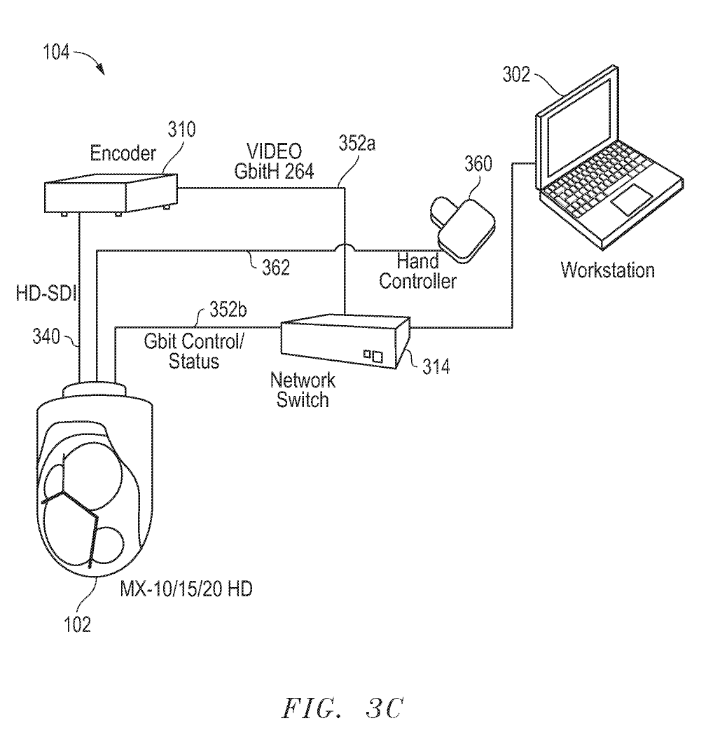

Also shown in FIG. 2A is optional KLV Encoder component 206 may be provided to receive metadata from different sources and encode that data with video stream into (Motion Imagery Standard Profile) MISP KLV format. As will be described in further detail with respect to FIG. 3A, the KLV encoded data may then be sent to a Video Encoder to be multiplexed in with the video and multicast to other TVS components. For example, in one exemplary embodiment KLV encoder 206 may be configured as a background service, to translate sensor status information (including pointing and geographic location of sensor 102) into a standard KLV format for metadata that may be compatible with mapping applications such as Google Earth, Envitia Maplink Pro, NASA World Wind, ArcMap, etc. The KLV metadata may then be transmitted to a video compressor/encoder component (e.g., such as a separate hardware compressor/encoder component) to be merged with the sensor video into a complete compressed video metadata transport stream 270. KLV data may also be routed to other devices on the network as needed. Other examples of network devices include, but are not limited to, datalinks, other software components (e.g., radar, comms,) etc. As an example, KLV data may be sent over relatively low rate satellite communications (SATCOM) to mission controllers acting as remote users 230 on the ground. In such an example, remote users 230 may be enabled to watch both aircraft and sensor footprints on Google Earth or interface of other suitable mapping application, even without viewing the video data itself, and may be enabled to point the sensor 102 from the displayed map over SATCOM across the network.

In one exemplary embodiment, KLV Encoder 206 may run without any operator intervention, although a user interface may be provided for KLV encoder 206 that may be used for installation, maintenance, and to verify that the application is running. In some installations and with some sensors the KLV Encoder component 206 may not be required. When required or otherwise present, it may be configured to automatically start upon bootup of the computer or other processing device/s upon which KLV Encoder 206 is running, or when an appropriate operator account is logged into on the computer or other processing device/s upon which KLV Encoder 206 is executing.

A Cursor-On-Target (COT) Manager component 204 may be present as shown as a service application that detects, receives and processes externally sourced targeting data, and formatting the data so that it can be available to both the TTM 226 and TSAM 224 for viewing. In one embodiment, one form of interoperability for TVS 104 may be provided for TVS 104 by the COT Manager component 204. In this embodiment, COT Manager 204 may listen on a specified port for standard Cursor-On-Target (COT) messages. When a COT message is received, the COT Manager 204 may be configured to reformat and transmit the message to the TVS 208 for insertion into the database 260, which in turn makes it available to the TTM 226 (e.g., under a “Nominations” tab) and the TSAM 224. In this manner, TVS 224 may be configured to receive information on items of interest from external sources 240.

In one exemplary embodiment, COT manager 204 may be present as a XML formatted schema that provides network data between services and applications using User Datagram Protocol (UDP), e.g., running in the background. In one exemplary embodiment, COT manager 204 may be configured to receive incoming targeting data as external COT messages (e.g., from external targeting sources 240) and to translate them into target nominations which may then show up or be displayed (e.g., made available to the user as “Nomination” tabs by TTM 226, e.g., on a “Nominations” tab of a display of the TTM 226) for an user to access and incorporate into an ongoing mission if desired. No user interaction may be required, e.g., other than verification that it is running in one embodiment. As with components 206 and 208, COT Manager 204 may be configured to automatically start upon bootup of the computer or other processing device/s upon which COT Manager 204 is running, or when an appropriate operator account is logged into on the computer or other processing device/s upon which COT Manager 204 is executing.

FIG. 3A illustrates one exemplary embodiment of the video/metadata physical architecture of TVS 104 as it may be configured in one exemplary embodiment to provide complete mission management of video Electro-Optical/Infrared (EO/IR) gimbaled sensor 102. In such an embodiment, TVS 104 may be configured to provide low latency encoding of EO/IR video, allowing for sensor control by interacting directly with the image pixels by geo-locating image pixels on the fly as they are received and rendered. Such pixel geo-location may be performed using any suitable methodology, and may be performed in one embodiment by KLV encoder 206 as the image pixels are received from sensor 102 together with sensor metadata that includes the centerpoint geolocation of the sensor field of view. For example, optical properties of sensor 102 (e.g., lens data, zoom ratio, slant range, etc.) and telemetry data from the platform (heading, pitch, roll) may be combined to extrapolate geolocation of each individual pixel in the sensor field of view from the provided centerpoint of sensor 102 field of view.

In the embodiment of FIG. 3A, sensor 102 is coupled as shown to functional components 206, 222, 208 that are programmed and executing on processing device/s of computer system 302, which in one exemplary embodiment may be a single computer (notebook, laptop or any other suitable computer configuration) that may be located on a sensor platform 100. However, any other suitable single computer or multi computer system and/or any other configuration of one or more processing devices (e.g., CPU, FPGA, ASIC, controller, microcontroller, etc.) may alternatively be employed. Thus, components 206, 222, and 208 may be provided as system software that is configured using a single computer that hosts all TVS software or functional modules, or as a multiple computer system with the TVS modules distributed among several computers.

As shown, the embodiment of FIG. 3A may be implemented to provide a MISB compliant compressed video recorder 208 with exploitation tools and database 260 such as previously described in relation to FIG. 2A. In this regard, functional components that may be present and executing on computer system 302 may include those components illustrated and described in relation to FIG. 2A including, for example, MISB compliant compressed video viewer TVV 222, TTM 226 and database application, sensor control tools 212, etc.

In the embodiment of FIG. 3A, sensor 102 may be coupled as shown to provide sensor video information 340 to one or more video encoder/s 310/312 for video compression and network transmission purposes. A compressed video data stream is then provided from video encoders 310/312 to functional (e.g., software) components 206, 222 and 208 for recording, display, exploitation, status/control functionality, and KLV data. Examples of suitable data encoders include, but are not limited to, a HaiVision Makito encoder 310 (for accepting High Definition-Serial Digital Interface HD-SDI/RS-170 or Air video information), a Delta Digital 6800R encoder 312 (for accepting HD or SD video information), etc. Sensor 102 may also provide KLV data in HD-SDI or other suitable format with the sensor video information across the same data path/s to KLV encoder/router 206. In this regard, KLV data may, for example, either be provided by HD-SDI directly to the encoder 310/312, or it may be provided by serial/Ethernet to the KLV Encoder 206 for formatting before then being sent to the encoder 310/312. The serial or Ethernet interface may also serve as the command port for the turret of sensor 102.

As also shown, platform navigation data source 390 may provide navigation metadata, e.g., from a separate global positioning system (GPS) data source, inertial guidance system (INS) data source, or a combination thereof. Although illustrated as a separate component in FIG. 3A, it will be understood that navigation data 390 for platform 100 may be provided from integral components of sensor 102. KLV encoder/router 206 may encode received metadata (e.g., including sensor metadata, navigation metadata, etc.) data with received video information stream (e.g., into MISP KLV format), which may be ultimately multicast as video transport stream data 350.

In one exemplary embodiment, a suitable network switch 314 (e.g., a Cisco SRW2008 switch or any other suitable network switch) may also be provided to receive compressed video 352/354 from video encoders 310/312, and to pass compressed video and associated data 350 to the mission system 302 executing on a computer system as descried elsewhere herein. In this regard, video encoders 310/312 may be configured to multi-cast compressed video data to the network, e.g. to allow recording and viewing simultaneously and/or to allow multiple operators to view the video data, live or recorded, or may be configured to single cast when system limitations dictate. As further shown, sensor 102 may also be coupled via Ethernet, Serial or other suitable data communication path 330 to directly provide KLV data (e.g., in HD-SDI or other suitable form) to KLV encoder 206 of TVS 104, as well as control and status communication. Other components of a mission system 302 that are not illustrated in FIG. 3A but which may also be communicatively coupled to network switch 314 include COT manager 204, TSAM 224 and TTM 226. Further switch 314 may be configured to provide the compressed video transport stream from video encoder/s 310/312 to remote system components colocated with remote user/s 230.

FIGS. 3B and 3C illustrate two different exemplary encoder configurations that may be employed in a TVS 104 implementation, it being understood that any other system configuration may be employed that is suitable for implementing one or more of the functions of TVS 140 described herein. FIG. 3B illustrates a gimbaled sensor 102 coupled to HaiVision Makito encoder 312, switch 314 and computer system 302 (e.g., portable notebook computer workstation) in a manner as previously described. As shown, a sensor hand controller 360 may also be coupled to communicate control signals 362 from an user to sensor 102. In this exemplary embodiment, an Ethernet-to-Serial terminal 370 (e.g., IOLAN server) may be provided to accept serial metadata 330 from sensor 102 and to provide this metadata as Ethernet data 372 to switch 314. Metadata 354b may also be provided from encoder 312 to Ethernet-to-Serial terminal 370 as shown, while video 354a is provided from encoder 312 directly to switch 314 as shown. As another example, FIG. 3C illustrates gimbaled sensor 102 coupled to Delta encoder 310, switch 314 and computer system 302. As with the embodiment of FIG. 3B, a sensor hand controller 360 may also be coupled to communicate control signals 362 from an user to sensor 102. In this exemplary embodiment, control/status communications 352b may be provided from sensor 102 to switch 314, while video 352a is provided from encoder 310 directly to switch 314 as shown.

During encoding and routing operations using the system of FIGS. 3A-3C, sensor video and metadata 350 may be multicast throughout the system 104 as motion imagery standards profile (MISP) 5.4 or 5.5 compliant video transport streams, or in any other suitable video transport stream format. As indicated above, in one exemplary embodiment KLV metadata may be provided by the KLV encoder/router 206 using the following steps: reading metadata across communication path 330 from the sensor serial, Ethernet or other suitable port, formatting it into KLV, and providing it to the encoder/s 310 and/or 312 for embedding into the compressed video transport stream. Additionally or alternatively, HD-SDI metadata, may be extracted by the encoder/s 310 and/or 312 and formatted into the compressed video transport stream. In the latter case, data may be supplemented by the KLV encoder/router 206 which may supply mission and security data (e.g., such as Mission ID, Platform ID, security classification fields) to encoder/s 310 and/or 312. In one embodiment, once the video transport stream data 350 is multicast, it may be received by two system components of FIG. 3A, the recorder/server 208 and/or TVV 222.

In one exemplary embodiment, video and metadata transport stream 350 may be received by recorder/server 208, and multiple transport streams (e.g., identified by a unique IP address and port) may be configured as channels in the recorder/server 208. Recording may be controlled, for example, by a user for each channel individually by check boxes in a control panel interface presented to the user, e.g., by TVV 222 of FIG. 2A. In such an embodiment, recorder/server 208 may allocate space in the mission system file system database 260 and record the video and metadata as, for example, MISP 5.5 compliant files. Each file is a chunk of video and metadata, and chunk sizes may be configurable by the operator (e.g., from about 1 minute to about 30 minutes). Other file sizes are possible, it being understood that larger file sizes will typically be slower to handle in the file system. At the same time the files are created in database 260, metadata may be extracted from the transport stream and used to create database entries corresponding to each file in the file system. In one exemplary embodiment, the database 260 may be SQL compliant and may provide a query capability to the user for retrieving video files based on metadata parameters. Other data may also be stored in the database 260, e.g., including keywords created during exploitation and entries for National Imagery Transmission Format (NITF) snapshots created during exploitation. This database and query system configuration may be implemented to provide a local or remote operator with immediate access to segments of video equating to geographic locations of the collected imagery, time within the mission of the collected imagery, bookmarked scenes of interest in the collected imagery. This capability may save many hours of watching collected video to find the items of interest within the body of collected imagery.

In another exemplary embodiment, video and metadata transport stream 350 may be received by the viewer component, e.g., TVV 222. The viewer 222 may extract the compressed pixel stream and render it into video frames, and may also extract the metadata stream and render it into viewable metadata in the viewer 222. Viewer 222 may transmit the metadata to other components that subscribe to it (e.g., maps, etc.). Multiple transport streams (e.g., IP address and port) may be configured as channels in the viewer 222, and each transport stream may be represented to a user, e.g., by a tab or button on the viewer frame. In such an embodiment, the user may select the transport stream they wish to view by clicking on one of the tabs or buttons.

A Query panel may also be provided by the viewer 222 to allow an user to search the archive in database 260 for stored video, stills, and bookmarks. In one embodiment, the query results may be filtered based on entries in various metadata fields on the query panel. Entries that meet the query parameters are returned as a list in the query panel. Operators may select a video, still, or bookmarked video to view by clicking and dragging the video onto the viewer surface. In one embodiment, videos may also be dragged directly from the file system onto the viewer as well.

In one embodiment, viewer 222 may also be configured with a video recorder (DVR) time bar that is present for either live or replayed videos. The operator may control the video by dragging the time icon backward and forward on the time bar, or by using VCR-like buttons, e.g., for Pause, Play, and Jump Backward. A single button may be provided by viewer 222 to place bookmarks into the database 260. These bookmarks may be referenced to a particular video file and offset into the file, providing the operator with a quick method of returning to points of interest in the video. These bookmarks may be annotated with keywords or phrases which are entered into the database 260 with the bookmark and may be queriable. In one exemplary embodiment, a Battle Box function may be present to allow the operator to annotate the video on the fly as he watches and drop the annotation into a bookmark whenever he wishes.

In another embodiment, a single button may be provided by viewer 222 for chips (snapshots or single frame still images) from the video. Chips may be placed in a Chips panel for further processing. When selected from the Chips panel, chips may be presented in a national imagery transmission format (NITF) viewer panel with associated metadata captured from the video metadata. Chips may be saved as NITF 2.1 files and may be added to the image database 260 for future queries. Chips may also be saved in any other suitable format, e.g., such as GeoTIFF, BMP, PNG, and/or JPEG formatted images. A single button may also be provided to enable a simple video editor. When such an embodiment is enabled, the operator may be allowed to select a section of video to extract to the Clips panel. Single or several clips may then be rendered into a video output file. Video clips may be rendered as transport stream, MPEG, AVI, and/or Windows Media Player files or any other suitable file format. Resolution and compression may be altered when the rendering is performed.

Viewer 222 may also be configured in one embodiment to provide complete control of sensors 102 such as WESCAM MX series EO/IR sensors and FLIR Systems Star Safire series EO/IR sensors. In one exemplary embodiment, detailed controls may be provided in a Sensor Control panel that replicate the controls available on a hardware joystick available from the sensor manufacturer. These controls of the Sensor Control panel may be configured to work over Internet Protocol networks, providing for multi-operator and remote control of the sensor when necessary. In addition to the detailed control, tactical control of the sensor 102 may be provided by intuitive, direct manipulation of the video frame, e.g., steering of the sensor 102 may be provided by clicking in the video frame and dragging the sensor 102 in the direction the operator directs. In this embodiment, a vector in the video frame may be present to provide operator feedback on the direction and speed of the sensor slew. The sensor 102 may also be slewed to a specific point in the video frame by clicking on a pixel at the geographic location desired. Control of the focus and zoom are provided on the center mouse wheel. Camera selection may controlled by clicking the center mouse wheel. It will be understood that any other user input configuration and/or type of input devices may be alternatively employed for similar functions.

Still referring to FIGS. 2 and 3, a target management database 260 may be provided in one exemplary embodiment for pre-planned and ad hoc targets. Targets may be entered into the database 260 manually by creating a new target and filling in various operator defined fields of viewer 222. Targets may be received from other entities in Cursor on Target (COT) formatted messages sent to a defined Port number. COT targets may be placed into a target nomination tab for further processing by the operator, and a history may be maintained of the changes made to any target. When connected to a sensor 102, the target manager provides the ability to slew to any target in the list, e.g., by right clicking the target and selecting Slew from a pop up menu or drop down list. As data is collected against specific targets, links may be created in the target database, allowing for rapid retrieval of all target specific products. Other formats such as SensorWeb may be utilized to receive target information into the database 260 by providing a small component that formats the data into appropriate format. Any message format that contains target location information may be utilized in this manner.

TVS 104 may be configured in one exemplary embodiment to interact with maps as clients. For example, metadata from the video stream 350 may be published to a known Port number by the viewer 222. Maps may subscribe by listening on that port number. Likewise, the sensor controller 212 listens on a Port number for sensor commands that may be received, for example, from the Viewer 222, the Target Manager 226, or from a map application such as TSAM 224. In this regard, TVS 104 may be configured, for example, with TSAM 224 that is based on a Google Earth application or other suitable map application (e.g., Envitia Maplink Pro, NASA World Wind, ArcMap, etc.) to provide map-based situational awareness. In one particular embodiment, video metadata may be displayed in Google Earth or other suitable mapping application interface as a dynamic aircraft model and associated sensor footprint. As video is played, the footprint of sensor platform (e.g., aircraft 100) and sensor 102 may be animated to provide real time or near real time situational awareness to the operator. Snapshots (e.g., NITF) from the video 350 may be displayed on the 3D Google Earth surface or other suitable mapping application interface. Google Earth or other suitable map application may also send pointing commands to the sensor 102 when the operator commands it. Additional data may be incorporated into TSAM 224, e.g., to provide complete situational awareness. TSAM 224 may subscribe to various sources of data. Metadata from video 350 may be published by TVV 222, while similarly, metadata on targets may published by TSAM 224. It will be understood that IP Ports are only one of the potential mechanisms for distributing data in a publish-subscribe architecture. Also possible are (Data Distribution Service (DDS)) and other middleware solutions.

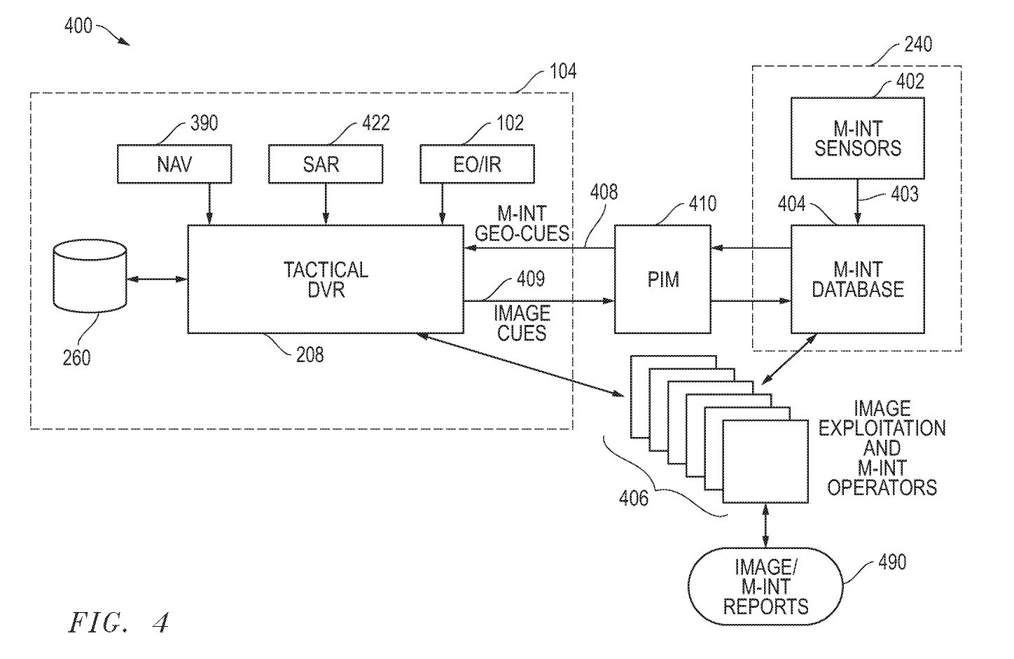

FIG. 4 illustrates one exemplary embodiment of a motion imagery cued exploitation (MICE) architecture 400 including a platform interface module (PIM) 410 that may be implemented in conjunction to interface components of a TVS 104 with one or more external sources 240 in the manner described elsewhere herein. It will be understood that only a portion of the components of TVS 104 are illustrated in FIG. 4, but that one or more of the other TVS components illustrated and described in relation to FIGS. 2 and 3 may also be present. Components of TVS 104 shown in FIG. 4 include platform navigation data source (NAV) 390 which may be provided, for example, as metadata from integral components of sensor 102, or from a separate global positioning system (GPS) data source, inertial guidance system (INS) data source, or a combination thereof.

As shown in FIG. 4, PIM 410 may be implemented as an interface between the one or more external sources 240, which in this embodiment are present in the form of Multi-Intelligence (SIGINT (signals), ELINT (Electronic), IMINT (imagery), HUMIT (Human), etc.) (M-INT) sensor/s 402. Such M-INT sensors 402 may be, for example, RF signal emitter sensors co-located on the same sensor platform 100 or on a separate sensor platform. As shown, collected data 403 from M-INT sensors 402 may be maintained in a M-INT database 404 that may be accessed by PIM 410, e.g., across a suitable network or other data link. Such collected data 403 may include sensor geo-location information, for example, geolocation data corresponding to a detected signal emitter position or signal emitter area (e.g., emitter ellipse). Synthetic Aperture Radar (SAR) sensor/s 422 may collect moving target indications (MTI) that are geo-locations of moving objects, even through cloud cover and at night. SAR sensors may also produce images which may be imported as NITF files. MTI may be plotted on the map and used to cue EO/IR sensors. NITF images may be treated just like snapshots.

As further shown in FIG. 4, PIM 410 may be configured to receive image sensor (e.g., EO/IR sensor) image cues 409 from tactical DVR 208 of TVS 104 that correspond to the stored geolocation of a sensor footprint or surveillance area 190 that has been imaged by sensor 102 and recorded and stored on database 260. PIM 410 may be coupled to access M-INT database 404 and based on image cues 409 to retrieve M-INT geo-cues 408 from database 404 that represent the M-INT sensor geo-location information (e.g., detected emitter geo-location or emitter geo-location area) obtained from M-INT sensor/s 402. PIM 410 may then be configured to provide TVS 104 with the retrieved M-INT geo-cues 408.

In one exemplary embodiment, PIM 410 may use M-INT image-cues 409 to select and retrieve M-INT sensor geo-location information that corresponds (e.g., overlaps) with EO/IR sensor image cues 409 provided by TVS 409. Using these provided M-INT geo-cues 408, tactical DVR 222 may be configured to overlay the M-INT sensor geolocation area (e.g., signal emitter geolocation or geolocated signal emitter area) on the image sensor surveillance area 190 of sensor 102. In one exemplary embodiment, TVS 104 may utilize the provided M-INT geo-cues 408 to aim the sensor 102 at a detected target and/or to place dynamic annotation on the video (e.g., such as detected target location ellipses) projected into an appropriate frame of reference from a sensor surveillance area 190

In addition to the above-described features, it will be understood that PIM 410 may be employed to implement features such as sensor cueing, Full Motion Video annotation, automatic chip-out, and reporting in real time, utilizing cues from other M-INT systems 402. The cueing M-INT systems 402 may be co-resident (e.g., on the same platform 100 and/or executing on the same computer system 302), or may be communicatively connected via data link to the imagery system components of TVS 104. In this regard, one or more of the separate components of MICE 400 (including TVS 104) may be implemented locally (e.g., in the air on platform 100) and/or remotely (e.g., on the ground in a data center of a facility 114 or a separate vehicle 110). In one exemplary embodiment, image data 406 may be forwarded from tactical DVR 208 and/or M-INT database 404 for other purposes, e.g., such as forwarding image data 406 to operators of M-INT sensors 402, forwarding extracted images 406 to electronic light table packages for further exploitation, embedded images in reports 490 and email, etc.

Additionally, in one exemplary embodiment, TVS 104 may be configured to utilize the KLV encoded metadata to update a map that is displayed by TSAM 224 with location of aircraft 100 (e.g., from NAV 390), sensor footprint/surveillance area 190, and viewpoint. As video is played in the Tactical Digital Video Player 208, TSAM 224 may be updated. Tracks and other data may be added to the displayed map of TSAM 224, e.g., to provide complete situational awareness, from mission plan to live sensor data. Still images extracted from the video may be rectified and geo-registered into the TSAM map. In one exemplary embodiment, images may also be draped in three dimensions (3D) on the map of TSAM 224 where terrain data is available.

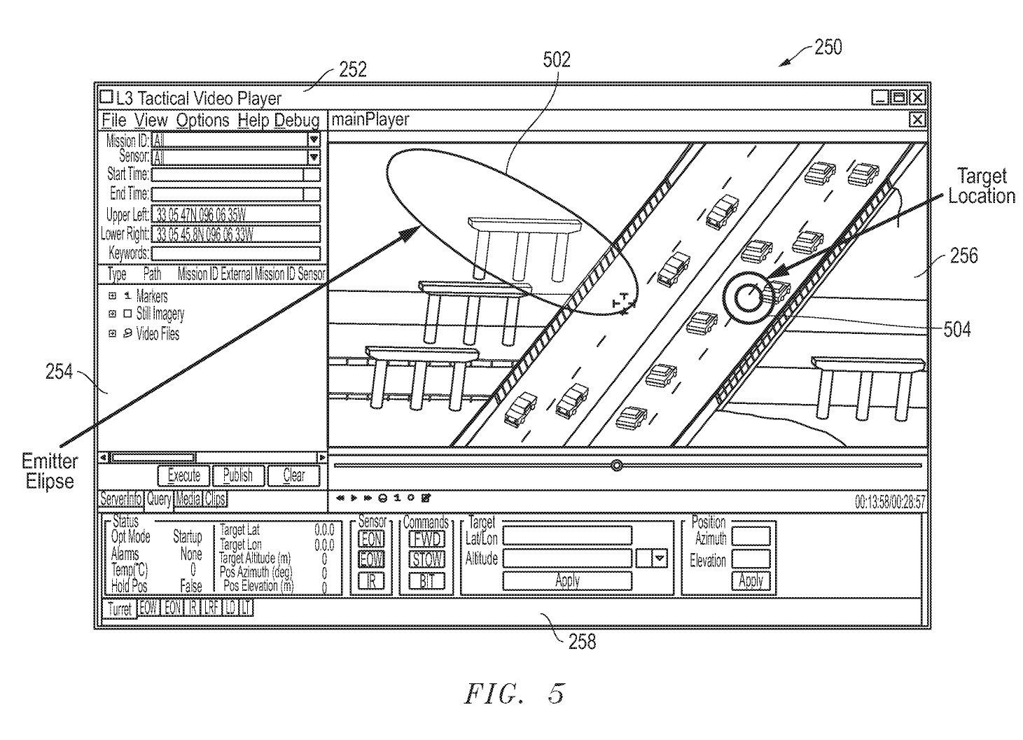

FIG. 5 illustrates one exemplary embodiment of a main window 250 of TVV GUI 222 of TVS 104 as it may be generated using the MICE architecture 400 of FIG. 4. In this exemplary embodiment, main window 250 of TVV GUI 222 displays emitter ellipse 502 or other target geometry and a target location 504 or other target symbology projected onto a frame of reference from sensor surveillance area 190 that is displayed on video viewing area 256 in real time over full motion video. In such an embodiment, emitter ellipse 502 represents a probability of confidence area within which a detected signal emitter is located (e.g., within X % probability that the geolocation of the signal emitter lies within the displayed geolocation of ellipse 502). As described above, geo-location data for displaying emitter ellipse 504 on video viewing area 256 may be provided to TVS 104 as M-INT geo-cues 408 received from one or more external M-INT sensors such as direction finder. Geo-location data for displaying target location or emitter geometry may also be provided by the TTM 226. Sensor location may be controlled by user input (e.g., mouse or joystick pointing) to control pointing of sensor 102 to coincide with the emitter geometry or target location and/or for targeting weapon systems that are linked to sensor 102 or weapon systems that utilize geolocation pixel metadata of target location 504 provided from TVS 104 to weapon targeting.

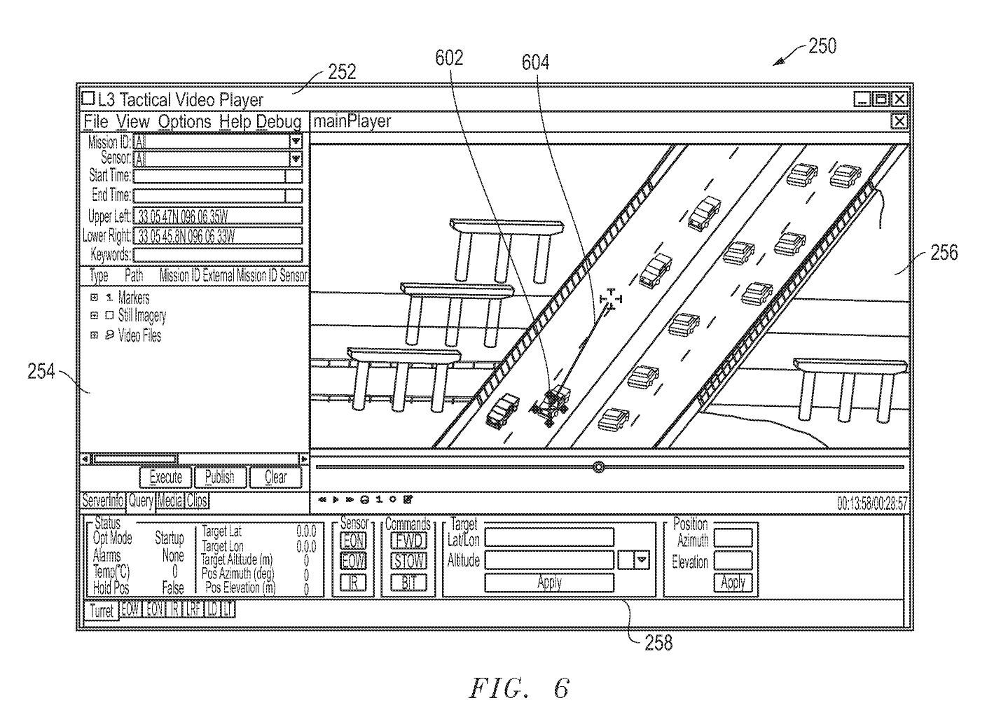

FIG. 6 illustrates one exemplary embodiment of a main window 250 of TVV GUI 222 of TVS 104 as it may be generated using the MICE architecture 400 of FIG. 4 to provide sensor steering in the video window 250 based on Azimuth and Elevation offsets and rates to simulate the direct panning of a camera lens. In this particular exemplary embodiment, FIG. 6 illustrates pacing (or tracking) of a vehicle 602 utilizing TVS slewing control. In this exemplary embodiment, the live video from sensor 102 may be used as a frame of reference to direct control of the turret of sensor 102 by stretching a displayed stretchable “rubber band” vector 604 in the direction the user wishes the turret of sensor 102 to go, e.g., using a mouse pointer. As the vector 604 is stretched further, the rate of slew of the turret is increased; and as the vector 604 is shortened, the rate of slew is decreased. As the head of the vector 604 is moved around the image 256, the direction of the turret slew is changed. This embodiment may be implemented to result in near instantaneous feedback to the user, giving him the feel of directly pointing the camera lens of sensor 102. The direct feedback of this embodiment may be utilized to allow the operator to learn turret control much more quickly, e.g., such that the manual tracking of vehicles may be learned in a few minutes or relatively short time. Internally, sensor controller 212 of TVS 104 may be configured to use the direction and magnitude of vector 604 to send azimuth and elevation magnitude commands to the turret to generate turret movement in the selected direction of the vector 604 and at a rate based on the magnitude of vector 604.

It will also be understood that one or more features and/or functions of the systems and methods described herein may be implemented in one exemplary embodiment by a computer program of instructions (e.g., computer readable code such as firmware code or software code) embodied in a non-transitory tangible computer readable medium (e.g., optical disk, magnetic disk, non-volatile memory device, etc.), in which the computer program comprising instructions is configured when executed (e.g., executed on a processing device such as a processor, microprocessor, microcontroller, controller, etc.) to perform at least a portion of the systems and methods described herein. A computer program of instructions may be stored in or on the non-transitory computer-readable medium residing on or accessible by one or more processing device/s (e.g., embodied in a computer system) for instructing the processing device/s to execute the computer program of instructions. The computer program of instructions may include an ordered listing of executable instructions for implementing logical functions in the processing device/s. The executable instructions may comprise a plurality of code segments operable to instruct the processing device/s to implement and perform at least a portion of the systems and methods disclosed herein. It will also be understood that one or more steps of the systems and methods described herein may be employed in one or more code segments of the present computer program. For example, a code segment executed by the processing device/s may include one or more steps of the disclosed systems and methods.

It will also be understood that the concepts and implementations presented may also be delivered utilizing a web browser to host the User Interface components 220.

While the invention may be adaptable to various modifications and alternative forms, specific examples and exemplary embodiments have been shown by way of example and described herein. However, it should be understood that the invention is not intended to be limited to the particular forms disclosed. Rather, the invention is to cover all modifications, equivalents, and alternatives falling within the spirit and scope of the systems and methods described herein. Moreover, the different aspects of the disclosed systems and methods may be utilized in various combinations and/or independently. Thus the invention is not limited to only those combinations shown herein, but rather may include other combinations.

What is claimed is:

1. A sensor system, comprising:
a first sensor;
at least one processing device coupled to receive image data and associated geospatial metadata from the first sensor, and coupled to provide video information to a video display; and
a sensor platform, with the first sensor being located on the sensor platform;
where the processing device is programmed to provide video information to a video display that is based at least in part on the received image data and the embedded associated geospatial metadata;
where the processing device is programmed to accept one or more commands from a user that are referenced to the embedded geospatial metadata associated with the image data to specify at least one selected geolocation within the image data, and at least one of the following:
where the processing device is programmed to respond to the user commands by selecting image data corresponding to the selected geolocation specified by the user commands and providing the selected image data as video information for display to the user on the video display, or
where the first sensor is a first pointable sensor, and where the processing device is programmed to respond to the user commands by controlling pointing of the first sensor based on the selected geolocation specified by the user commands, or
a combination thereof.

2. The system of claim 1, where the first sensor comprises at least one of a pointable electro-optic or infrared sensor that is pointable to produce the image data from the first sensor that comprises a movable surveillance area; where the image data from the first sensor comprises multiple pixels of a sensor image; where the processing device is configured to geo-locate the multiple image pixels of the sensor image on the fly as they are received and rendered; and where the processing device is programmed to respond to the user commands by controlling pointing of the first sensor to move the surveillance area based on the selected geolocation specified by the user commands.

3. The system of claim 1, further comprising the video display; where the sensor platform, the at least one processing device, first pointable sensor, and video display are each located on the sensor platform; where the first sensor comprises at least one of a pointable electro-optic or infrared sensor that is pointable to produce the image data from the first sensor that comprises a movable surveillance area; where the image data from the first sensor comprises multiple pixels of a sensor image; where the processing device is configured to geo-locate the multiple image pixels of the sensor image on the fly as they are received and rendered; and where the processing device is programmed to respond to the user commands by controlling pointing of the first sensor to move the surveillance area based on the selected geolocation specified by the user commands.

4. The system of claim 1, further comprising a database that is coupled to be accessed by the at least one processing device and configured to store historical image data and associated geospatial metadata from the first sensor; and where the processing device is programmed to:
provide the received image data with the associated geospatial metadata for storage as the historical image data in the database,
respond to the user commands by selecting and retrieving historical image data from the database based on the selected geolocation specified by the user commands, and
provide the selected image data back to the user as video information for display to the user on the video display.

5. The system of claim 1, where the processing device is configured to receive external geolocation information from at least one second sensor that is external to the system and not located on the sensor platform; and at least one of following:
where the processing device is programmed to project dynamic annotation information based on the external geolocation information from the second external sensor on the selected image data for display to a user on the video display, or
where the first sensor is a first pointable sensor, and where the processing device is programmed to control pointing of the first sensor based on the external geolocation information from the second external sensor, or
a combination thereof.

6. The system of claim 1, where the sensor platform comprises an aircraft; and where the system further comprises a navigation data source that is also located on the sensor platform, the navigation data source comprising at least one of a global positioning system (GPS) data source, inertial guidance system (INS) data source, or a combination thereof; and where the processing device is coupled to receive navigation metadata from the navigation data source and is configured to encode the navigation metadata with the received image data and the embedded associated geospatial metadata.

7. The system of claim 1, where the first sensor comprises at least one of a pointable electro-optic or infrared sensor that is pointable to produce the image data from the first sensor that comprises a movable surveillance area; and where the processing device is configured to:
accept one or more commands from a remote user that is not located on the sensor platform, the remote user commands being referenced to the embedded geospatial metadata associated with the image data to specify at least one selected geolocation within the image data; and
respond to the remote user commands by controlling pointing of the first sensor to move the surveillance area based on the selected geolocation specified by the remote user commands.

8. A method comprising:
providing a first sensor;
providing a video display;
providing at least one processing device coupled to receive image data and associated geospatial metadata from the first sensor, and coupled to provide video information to the video display;
using the processing device to provide video information to the video display that is based at least in part on the received image data and the embedded associated geospatial metadata;
using the processing device to accept one or more commands from a user that are referenced to the embedded geospatial metadata associated with the image data to specify at least one selected geolocation within the image data, and at least one of the following:
using the processing device to respond to the user commands by selecting image data corresponding to the selected geolocation specified by the user commands and providing the selected image data as video information for display to the user on the video display, or
where the first sensor is a first pointable sensor, and using the processing device to respond to the user commands by controlling pointing of the first sensor based on the selected geolocation specified by the user commands, or
a combination thereof.

9. The method of claim 8, where the first sensor comprises at least one of a pointable electro-optic or infrared sensor that is pointable to produce the image data from the first sensor that comprises a movable surveillance area; and where the method further comprises responding to the user commands by controlling pointing of the first sensor to move the surveillance area based on the selected geolocation specified by the user commands.

10. The method of claim 8, further comprising a database coupled to be accessed by the at least one processing device and configured to store historical image data and associated geospatial metadata from the first sensor; and where the specified selected geolocation is a historical target or areas of interest that is stored in the database.

11. The method of claim 8, further comprising a database coupled to be accessed by the at least one processing device and configured to store historical image data and associated geospatial metadata from the first sensor; and where the method further comprises:
using the processing device to provide the received image data with the associated geospatial metadata for storage as the historical image data in the database,
responding to the user commands by selecting and retrieving historical image data from the database based on the selected geolocation specified by the user commands, and
providing the selected image data back to the user as video information for display to the user on the video display.

12. The method of claim 8, further comprising:
providing the processing device, video display, and first pointable sensor as part of a system;
receiving external geolocation information from at least one second sensor that is external to the system; and at least one of:
using the processing device to project dynamic annotation information based on the external geolocation information from the second external sensor on the selected image data for display to a user on the video display, or
using the processing device to control pointing of the first sensor based on the external geolocation information from the second external sensor, or
a combination thereof.

13. The method of claim 8, where the image data from the first sensor comprises multiple pixels of a sensor image; and where the method further comprises using the processing device to geo-locate the multiple image pixels of the sensor image on the fly as they are received and rendered.

14. The method of claim 8, where the at least one processing device, first sensor, and video display are located on the same sensor platform that comprises an aircraft.

15. The method of claim 8, where the at least one processing device, first pointable sensor, and video display are configured to be located on the same sensor platform; where the first sensor comprises at least one of a pointable electro-optic or infrared sensor that is pointable to produce the image data from the first sensor that comprises a movable surveillance area; and where the method further comprises using the processing device to:
accept one or more commands from a remote user that is not located on the sensor platform, the remote user commands being referenced to the embedded geospatial metadata associated with the image data to specify at least one selected geolocation within the image data;
respond to the remote user commands by controlling pointing of the first sensor to move the surveillance area based on the selected geolocation specified by the remote user commands.

16. The method of claim 8, where the at least one processing device, first sensor, and video display are located on the same sensor platform; and where the method further comprises using the processing device to:
receive navigation metadata from a navigation data source that is also located on the sensor platform, the navigation data source comprising at least one of a global positioning system (GPS) data source, inertial guidance system (INS) data source, or a combination thereof; and
encode the navigation metadata with the received image data and the embedded associated geospatial metadata.

17. The method of claim 8, further comprising using the processing device to display to the user on the video display a geospatial map that is based at least in part on the received image data and the embedded associated geospatial metadata so as to provide a geospatial context for the displayed image data.

18. A system comprising:
at least one processing device configured to receive image data and associated geospatial metadata from a first sensor, the processing device being programmed to execute at least one image server component and at least one user interface component;
where the processing device is programmed to execute the image server component to provide the received image data with the associated geospatial metadata to the user interface components, the associated geospatial metadata being embedded with the image data;
where the processing device is programmed to execute the user interface component to provide a display to a user that is based at least in part on the received image data and the embedded associated geospatial metadata;
where the processing device is programmed to execute the user interface component to accept commands from a user that are referenced to the embedded geospatial metadata associated with the image data to specify at least one selected geolocation within the image data, and in response to the user commands to provide control data to the image server component that is referenced to the embedded geospatial metadata associated with the image data to specify the at least one selected geolocation, and at least one of the following:
where the processing device is programmed to execute the image server component to respond to the control data by selecting image data corresponding to the selected geolocation specified by the control data and providing the selected image data back to the user interface component for display to the user, or
where the first sensor is a first pointable sensor, and where the processing device is programmed to execute the image server component to respond to the control data by controlling pointing of the first sensor based on the selected geolocation specified by the control data, or
a combination thereof.

19. The system of claim 18, where the first sensor comprises at least one of a pointable electro-optic or infrared sensor that is pointable to produce the image data from the first sensor that comprises a movable surveillance area; and where the processing device is programmed to execute the image server component to respond to the control data by controlling pointing of the first sensor to move the surveillance area based on the selected geolocation specified by the control data.

20. The system of claim 18, further comprising a database coupled to be accessed by the at least one processing device and configured to store historical image data and associated geospatial metadata from the first sensor; and where the specified selected geolocation is a historical target or areas of interest that is stored in the database.

21. The system of claim 18, further comprising a database coupled to be accessed by the at least one processing device and configured to store historical image data and associated geospatial metadata from the first pointable sensor; where the processing device is programmed to execute the image server component to provide the received image data with the associated geospatial metadata for storage as the historical image data in the database; where the processing device is programmed to execute the image server component to respond to the control data by selecting and retrieving historical image data from the database based on the selected geolocation specified by the control data and providing the selected image data back to the user interface component for display to the user.

22. The system of claim 18, where the processing device is configured to receive external geolocation information from at least one second sensor that is external to the system; and where the processing device is programmed to at least one of:
execute the user interface component to project dynamic annotation information based on the external geolocation information from the second external sensor on the selected image data for display to a user, or
execute the image server component to control pointing of the first sensor based on the external geolocation information from the second external sensor.

23. The system of claim 18, where the image data from the first sensor comprises multiple pixels of a sensor image; and where the processing device is programmed to execute the image server component to geo-locate the multiple image pixels of the sensor image on the fly as they are received and rendered.

24. The system of claim 18, where the at least one processing device and all other components of the system are located on the same sensor platform that comprises an aircraft.

25. The system of claim 18, where the at least one processing device and components of the system are configured to be located on the same sensor platform; where the processing device is programmed to execute the image server component to receive navigation metadata from a navigation data source that is also located on the sensor platform, the navigation data source comprising at least one of a global positioning system (GPS) data source, inertial guidance system (INS) data source, or a combination thereof; and where the processing device is programmed to execute the image server component to encode the navigation metadata with the received image data and the embedded associated geo spatial metadata.

26. The system of claim 18, where the at least one processing device and components of the system are configured to be located on the same sensor platform; where the first sensor comprises at least one of a pointable electro-optic or infrared sensor that is pointable to produce the image data from the first sensor that comprises a movable surveillance area; where the processing device is programmed to execute the user interface component to accept commands from a remote user that is not located on the sensor platform, the commands being referenced to the embedded geospatial metadata associated with the image data to specify at least one selected geolocation within the image data; where the processing device is programmed to execute the user interface component in response to the remote user commands to provide control data to the image server component that is referenced to the embedded geospatial metadata associated with the image data to specify the at least one selected geolocation; and where the processing device is programmed to execute the image server component to respond to the control data by controlling pointing of the first sensor to move the surveillance area based on the selected geolocation specified by the control data.

27. The system of claim 18, where the processing device is programmed to execute the user interface component to provide a display on a geospatial map to a user that is based at least in part on the received image data and the embedded associated geospatial metadata so as to provide a geospatial context for the displayed image data.
